(19) United States
(12) Patent Application Publication
(10) Pub. No.: US 2002/0056453 A1
(43) Pub. Date: May 16, 2002

(54) Blowing device

(76) Inventors: Andreas Klopp, Munchen (DE); Stefan Schatzl, Schondorf (DE)

Correspondence Address: LAUBSCHER & LAUBSCHER, SUITE 300, 745 SOUTH 23RD STREET, ARLINGTON, VA, 22202, US

(21) Appl. No.: 09/903,564

(22) Filed: Jul. 13, 2001

Related U.S. Application Data
(63) Continuation of application No. PCT/EP00/00365, filed on Jan. 18, 2001.

(30) Foreign Application Priority Data
Jan. 18, 1999 (DE) 199 01 780.8

(51) Int. Cl. A62B 7/00

(52) U.S. Cl. 128/204.18

(57) ABSTRACT

The present invention relates to a blowing device, in particular for use in a respiration device for delivering a respiration gas. The blowing device according to the invention includes an impeller which is driven by way of a drive device and which delivers a respiration gas to an outflow passage. On the way into that outflow passage the gas being delivered flows over a flow breakaway step which together with a spirally enlarging peripheral wall deflects the gas as it flows immediately out of the radial impeller. The invention also relates to a CPAP-apparatus fitted with such a blowing device.

The invention concerns a blowing device. In particular the invention concerns a blowing device for providing respiration air in a respiration device, for example a CPAP respiration apparatus.

In known blowing devices a housing is usually provided with an inlet passage and an outlet passage and an impeller. The fluid which is to be compressed or accelerated is drawn in by way of the inlet passage, compressed in the housing by the impeller which is driven by way of a drive device, and discharged by way of the outlet passage. Here, the impeller is accommodated concentrically in a cylindrical housing. The outlet passage is formed by a tube portion mounted at an opening in the cylindrical wall of the housing.

The known blowing devices involve the problem that a relatively high level of noise is generated. When those devices are in use with a low ambient noise level, the amount of noise which occurs is often perceived as being unpleasant.

The object of the invention is to provide a blowing device, in particular for a CPAP apparatus, which is distinguished by low levels of operating noise.

In accordance with the invention that object is attained by a blowing device comprising a housing, at least one impeller accommodated therein, an intake opening and a discharge flow passage, wherein defined in the housing in conjunction with the impeller is a flow path which extends from a first axial level of the housing, which level has the intake opening, by way of a step into the discharge flow passage.

That makes it possible to considerably reduce the amount of flow noises involved, in an advantageous manner and in particular also in a manner which can be conveniently and desirably implemented from the point of view of production engineering. By virtue of the improvement achieved in quietness of operation, it is advantageously possible to forego additional sound-insulating means and in that respect it is possible to arrive at an extremely compact structure. There are advantages also in terms of manufacturing costs.

Advantageously, the impeller is arranged in the housing in axially stepped relationship with respect to the discharge flow passage, wherein the housing has a spirally extending wall so that the fluid accelerated by the impeller flows over a flow breakaway step or edge. The step which is preferably operative as a flow breakaway step can be formed directly by the housing.

As an alternative thereto or also in combination with the specified features, the object set forth hereinbefore is also attained by a blowing device comprising a housing, at least one impeller accommodated therein, and a drive device for driving the impeller, wherein an intake flow path is established in an intake region in the housing, the intake region being disposed upstream of the impeller and the intake flow path extending along a spirally wound course to an intake opening.

That configuration also advantageously provides for a considerable reduction in the blower noise.

Advantageously, the housing has a peripheral wall which in its configuration follows a spiral course which enlarges radially in the direction of rotation of the impeller. The spiral course preferably substantially corresponds to a logarithmic spiral.

In a particularly advantageous fashion the discharge flow passage follows a tangential continuation of the spiral course which is advantageously defined by the housing.

The step which projects into the flow path preferably forms a flow breakaway step. The step is preferably of a height (H) which corresponds at least to the axial height of the impeller.

Preferably the flow breakaway step extends between the largest and smallest radii (rₘₐₓ, rₘᵢₙ) of the housing spiral in the direction of operation of the impeller.

The impeller in accordance with a particularly preferred embodiment of the invention is arranged in sunk relationship in a recess and the exit flow from the recess into the discharge flow passage goes by way of the above-mentioned flow transfer edge which extends substantially at the axial height level of an adjacent peripheral edge of the impeller.

Advantageously, the intake opening is arranged in a bottom means and the discharge flow passage is arranged at a side which is separated by the turbine wheel.

A still further reduction in operating noise can advantageously be achieved by the provision of sound insulating means, for example in the form of layers of insulating material, in and/or on the housing.

An embodiment of the invention which is particularly advantageous from points of view related to structural mechanics is afforded if the housing is in the form of an integral member with guide walls which are formed in one piece. In that case the housing is preferably in the form of a plastic injection molding or an aluminum die casting.

In accordance with a particular aspect of the invention an extreme degree of operating smoothness and quietness is achieved by the housing being formed from an elastomer material, in particular silicone rubber. That advantageously suppresses both sound coupling-in phenomena and also sound propagation. That advantageously provides for resilient suspension of the drive device. In that way, the contribution of magnetic effects, bearing noises and vibration caused by unbalance to the overall operating noise spectrum is reduced.

The impeller is preferably accommodated in a recess whose axial length (L) is greater than the axial depth (t) of the impeller, wherein the recess is defined by a peripheral wall which radially enlarges in the direction of rotation of the impeller, and provided in the transitional region to the discharge flow passage is an outlet opening disposed at an axial level which is axially displaced from the impeller.

The term ‘blowing device’ is used herein to stand for the term ‘turbine’ used in the priority application. The impeller used is preferably a radial or semi-radial impeller. The vanes or the passages defined thereby are preferably curved rearwardly. When the impeller is in the form of a radial impeller, it preferably has vane passage coverings on both sides. Preferably the impeller is made from a plastic material and coupled to a motor shaft by way of a retaining detent engagement structure, possibly in conjunction with a press or clamping fit. As an alternative thereto the impeller can also be screwed to a flange portion of the motor by way of a seating surface which is preferably of large area.

Further developments which are particularly advantageous in regard to a particularly high level of operating smoothness and quietness and also from points of view relating to production engineering, tooling and assembly procedures, are set forth in the appendant claims.

The blowing device according to the invention is described hereinafter by means of a preferred embodiment with reference to the drawing in which:

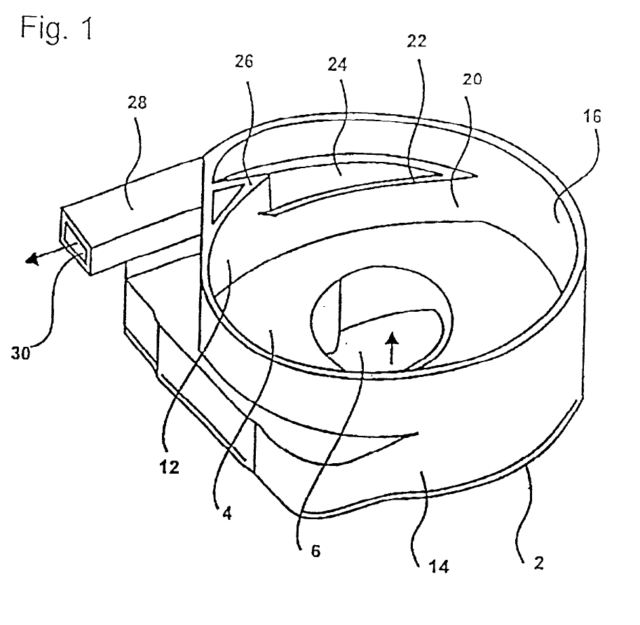

FIG. 1 shows a perspective view of a housing of a blowing device according to the invention (without cover and impeller),

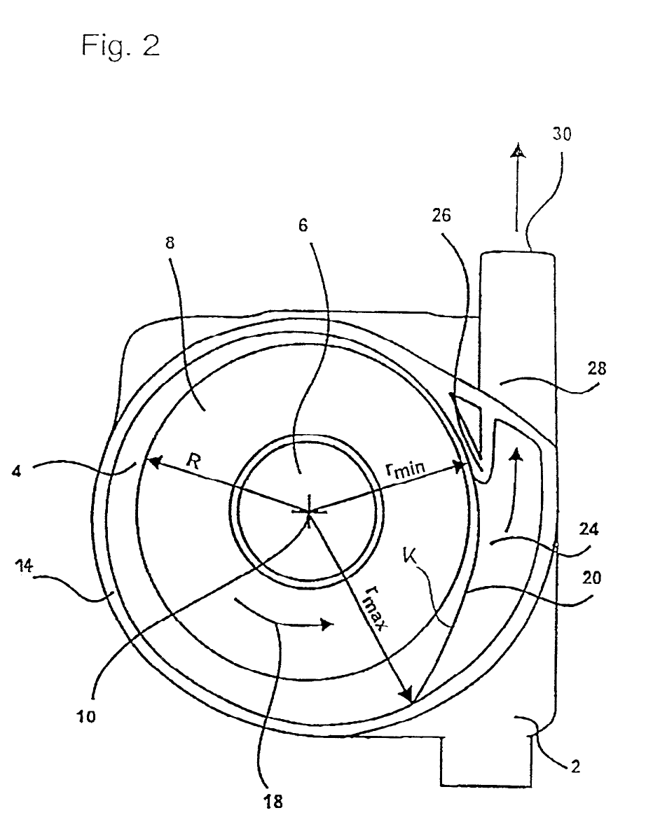

FIG. 2 is a view of the blowing device according to the invention with the housing cover removed,

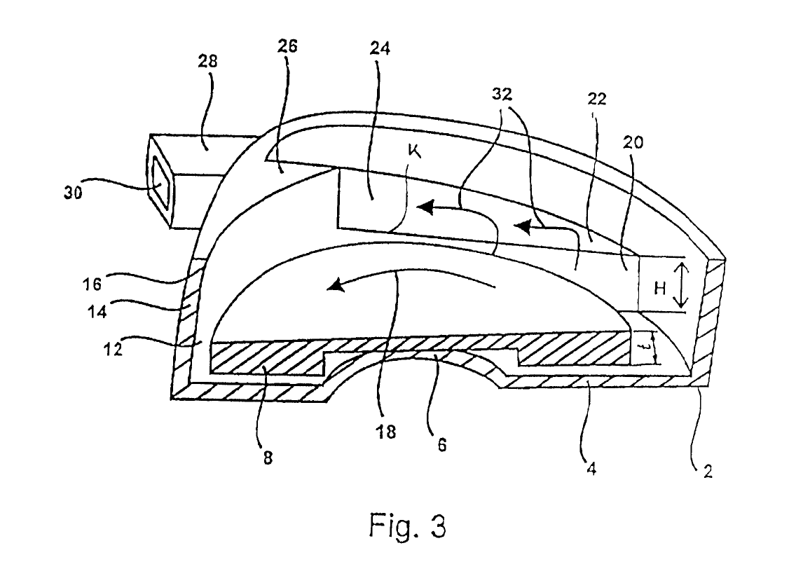

FIG. 3 is a simplified perspective view in cross-section of the blowing device according to the invention,

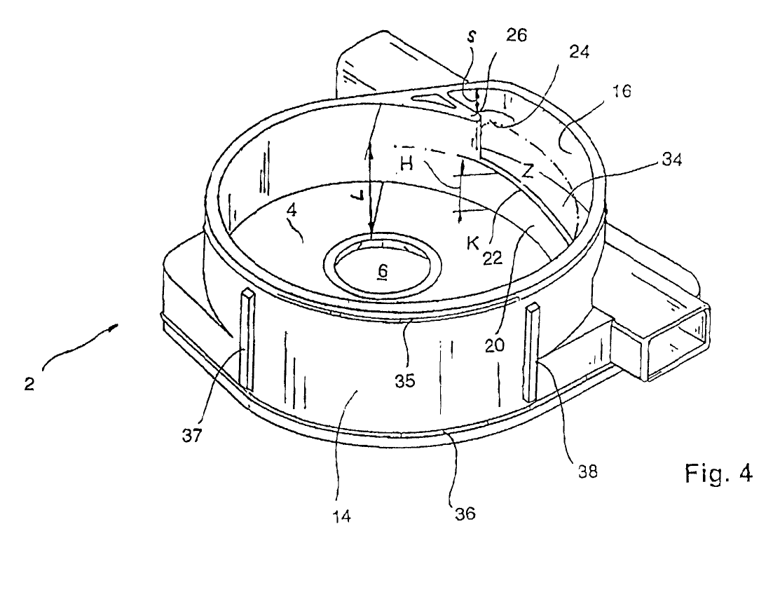

FIG. 4 is a perspective view of the impeller housing viewing on to an outflow passage portion which enlarges directly downstream of the flow breakaway edge,

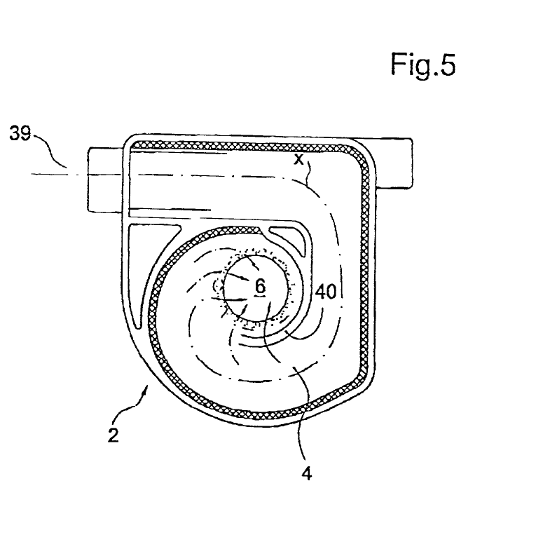

FIG. 5 is a view of the impeller housing from below, viewing on to the feed flow passage region,

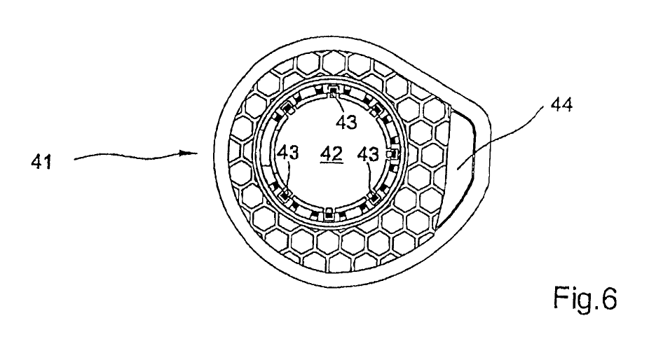

FIG. 6 is a plan view of a cover element for closing off the increased-pressure region with integrally formed holding claws for fixing a blower motor, and

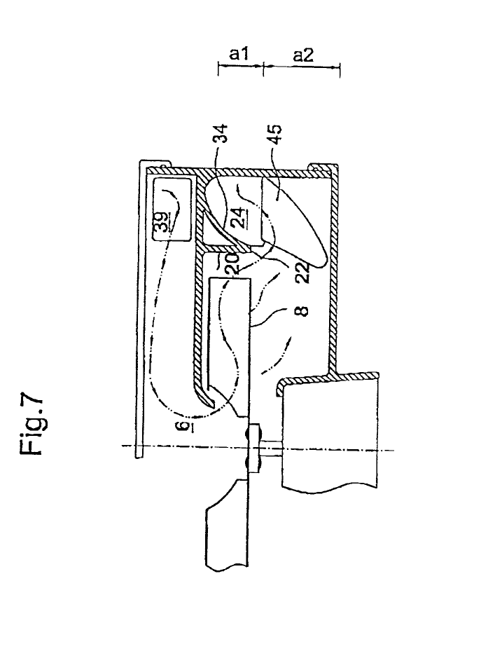

FIG. 7 is a simplified axial view to illustrate the flow path from an intake region beyond the impeller to the discharge flow passage.

FIG. 1 shows a perspective view of the housing 2 of the blowing device. Provided in a bottom region 4 of the housing 2 is an induction intake opening 6 which opens into an induction intake passage (not visible in the Figures) at the underside of the housing, by way of which the fluid to be compressed or accelerated is sucked in. The intake passage formed at the underside of the housing 2 is preferably closed by a cover (not shown) in the assembled condition. Provided in the interior of the housing 2 is at least one impeller 8 which is driven by way of a drive device (not shown). The drive device can be provided both inside and outside the housing 2. The impeller 8 is of an outside diameter R and rotates about an axis of rotation 10, as shown in FIG. 2. The impeller 8 is provided in the housing in a first axial portion 12 which is set at a lower depth. In that first axial portion 12, the impeller is surrounded by a peripheral wall, leaving an intermediate space. The housing 2 has a substantially spiral-shaped housing wall 14 which on the one hand defines the first axial portion 12 set at the lower depth, and on the other hand a second axial portion 16 which projects somewhat therebeyond. The wall 14 of the housing 12 is preferably designed at least in a portion-wise manner in the form of a logarithmic spiral, in which respect the following equations apply:

r=rₘᵢₙ·e^{max}

m=cot(k·π/2)

r: current radius

rₘᵢₙ: starting radius or minimum radius

m: opening factor; and

α: current angle for the radius r.

The factor k is to be so selected that the correct or desired opening angle of the spiral is achieved. For that purpose k is to be selected from a range of between 0 and 1.

Besides the preferred logarithmic spiral for the wall 14 of the housing 2 it is however also possible to use other spirals such as for example an Archimedes' spiral or a hyperbolic spiral, for the blowing device according to the invention.

The radius R of the impeller 8 is in that respect preferably at least 1 mm smaller than the minimum radius rₘᵢₙ of the housing wall 14. The housing wall 14 opens, in relation to the direction of rotation of the impeller 8, along the spiral, to a maximum radius rₘₐₓ. This means that the radial gap formed between the impeller 8 and the housing wall 14 increases in the direction of impeller rotation, starting from the minimum radius rₘᵢₙ to the maximum radius rₘₐₓ of the housing wall 14.

In opposite relationship to the direction of rotation of the impeller 8, as indicated by an arrow 18, between the minimum radius rₘᵢₙ and the maximum radius rₘₐₓ of the housing wall 14, there is a flow breakaway step 20. This breakaway step 20 of the height H defines in the illustrated embodiment the axial extent of the first deeper axial portion 12 and the second axial portion 16. The height H of the breakaway step 20 preferably corresponds at least to the axial structural depth of the impeller. The flow breakaway step 20 preferably has a breakaway edge 22. The fluid which is drawn in and accelerated by the impeller 8 flows along the housing wall 14 over the flow breakaway step 20 into an outlet or discharge flow passage 24.

The transition from the actual impeller chamber to the discharge flow passage 24 is essentially formed by the flow breakaway step 20 and an extension of the spirally extending outer housing wall 14. This means that the discharge flow passage 24, or the entry mouth region thereof, is set higher with respect to the impeller 8 by the height H of the breakaway step 20. The discharge flow passage 24 preferably also has a radially further inwardly disposed wedge or taper portion 26 and a discharge flow connection portion 28 with an outlet opening 30. The outlet or discharge flow passage 24 can preferably also be covered by the cover (not shown) when mounted on the housing 2.

As shown in FIGS. 1 to 3 and described hereinbefore, the flow breakaway stage 20 extends, as viewed in the direction of rotation of the impeller 8, from the maximum radius rₘₐₓ to the minimum radius rₘᵢₙ of the housing wall 14 and preferably has a breakaway edge 22. The flow breakaway step 20 can however also be still longer, that is to say for example it can be curved more greatly or it can begin further in a direction in opposite relationship to the direction of rotation 18 of the impeller 8. Furthermore, it is also possible for the flow breakaway step 20 to be designed of variable height H, for example of a height which increases in the direction of rotation 18 of the impeller 8. In regard to the configuration of the flow breakaway step 20 or the breakaway edge 22, it is particularly advantageous for it to be of a sufficient length to substantially avoid the production of noise. That is implemented in particular by virtue of the fact that the fluid which is accelerated by the impeller 8 flows along the housing 14 until it reaches the flow breakaway step 20 and is there forced to flow over the step into the discharge flow passage 24 as indicated by the arrows 32. The flow breakaway step 20 and in particular with the breakaway edge 22 provides that the accelerated fluid is changed in direction, braked and/or put into a turbulent state, and flow noises of the turbine, in particular in the upper frequency range (‘piping sounds’) are avoided in a surprisingly effective manner.

The housing 2 of the blowing device according to the invention is preferably an integral component such as for example a plastic injection molding or an aluminum die casting. However differing housing structures are also possible for the blowing device according to the invention. The impeller 8 is preferably in the form of a radial impeller wheel, in particular with rearwardly curved blades or vanes, for accelerating and/or compressing fluids, being drivable by way of a drive device such as for example an electric motor. The drive device for the impeller can be provided both inside and also outside the housing 2. The electric motor can be in the form of a brush-less motor and may possibly have sensors, for example Hall effect sensors, for detecting the speed of rotation.

In order further to reduce the level of sound emission of the blowing device according to the invention, it is possible to provide sound insulating means, in particular on or in the housing 2. A sound insulating means of that kind is preferably formed from a foam material or a soft material.

In the embodiment of the blowing device housing as shown in FIG. 4, to accommodate the impeller (FIG. 3, reference 8) the device has a recess which is of an axial depth L which is greater than the axial depth t of the impeller 8.

The recess is delimited by a bottom surface 4 which has the induction intake opening 6 already referred to in connection with FIG. 1. In the assembled condition of the blowing device the impeller is arranged in the recess in such a way that it is in an axial region which is defined between the bottom surface 4 and the axial heightwise level of the breakaway edge 22. Disposed at an axial level which is axially spaced from the impeller is a through opening Z, by way of which the delivered gas can flow away into the discharge flow passage 24.

In order to pass into the discharge flow passage 24, the gas which is delivered by the impeller flows over the step 20 or the uppermost breakaway edge 22 thereof. That provides for surprisingly effective eradication of the flow noises caused by the impeller, and prevents such noises from being propagated into the discharge flow passage 24. Above the breakaway edge 22 the peripheral wall 16 moves back radially outwardly along a spiral path and in so doing passes directly into a corresponding wall portion of the discharge flow passage 24. In the embodiment illustrated here, disposed behind the flow breakaway edge 22 is a wall 34 which drops away inclinedly and which also forms a transition into a wall delimiting the discharge flow passage 24.

The housing wall 14 is provided with latching devices 35, 36, by way of which correspondingly complementary cover elements can be latched directly to the housing 2. In this case the axial position of the impeller is established by abutment elements 37, 38 against which a cover element which will be described in greater detail hereinafter with reference to FIG. 6 abuts.

In the embodiment illustrated here, the recess which is provided to accommodate the impeller is almost of an axial depth L, which is three times the impeller 8. The impeller 8 is here in the form of a radial impeller and has a plurality of rearwardly curved blade or vane passages. The blade or vane passages are preferably provided at a predetermined unequal pitch distribution in order still further to obviate resonance phenomena. The inner peripheral wall of the recess can be roughened in order still further to enhance the sound-absorption capability of that wall. It is also possible to provide a plurality of micro-projections, whereby the sound-absorption characteristics of the corresponding wall are also still further improved.

FIG. 5 shows a preferred embodiment of the feed flow region of the blowing device. The feed flow to the induction intake opening 6 which is here arranged substantially centrally takes place along an induction intake path X which is also of a spirally wound configuration and which is defined by walls formed integrally with the housing 2. The peripheral region of the intake opening 6, which faces towards the feed flow side, is of a rounded configuration here, thereby providing for a particularly low level of noise in terms of the feed flow of the inducted air directly into a central region of the impeller. In the embodiment illustrated here, the wall of the housing 2, which defines the flow path X, is additionally lined with a sound-absorbent foam material, thereby preventing the operating noises of the blowing device from being propagated towards the induction intake passage 39. The wall 40 which is directly adjacent to the intake opening 6 and which delimits the intake path X is chamfered in such a way that it tapers off in the flow direction towards the bottom plate 4.

FIG. 6 shows a cover element which can be brought into engagement with the latching device identified by reference numeral 35 in FIG. 4. The cover element 41 is provided with a reinforcing structure which is here formed by honeycomb-like limbs, whereby on the one hand this provides for sufficiently rigid suspension of the drive device (not shown), while on the other hand vibration of the cover element is suppressed. The cover element 41 has a motor-receiving opening 42 which is bordered by a plurality of claw elements 43 which can latchingly engage into a recess provided at the motor side. In the embodiment illustrated here the cover element has a radially projecting cover portion 44 in which there is defined a ramp which, when the cover element 41 is fitted, drops away into the discharge flow passage 24. In its end which is directly adjacent to the discharge flow passage 24, the ramp 45 is of such a configuration that it compensates for the projection dimension indicated in FIG. 4 by the letter s, so that this configuration affords a substantially smooth feed flow also in relation to the top side of the passage.

FIG. 7 shows once again, in greatly simplified form, the flow path of the gas which is sucked in and delivered by way of the impeller. As can be seen from the Figure, the flow path extends from the intake passage 39 along a spiral path through the intake opening 6, flowing over the rounded peripheral edge thereof. After passing through the intake opening 6, the flow path goes through the impeller 8 and is then deflected in the axial direction by the peripheral wall 16 or the step 22, and then passes over the breakaway edge 22. Downstream of the breakaway edge 22, the gas which is now under an increased pressure flows away into the discharge flow passage 24, along the wall 34 which drops away. The flow of gas into the discharge flow passage portion 24 is also assisted by the ramp 45 which falls away inclinedly as is also indicated here.

As can be clearly seen from the view in FIG. 7, the impeller is disposed within the housing 2 in a first axial portion al, whereas the discharge flow of the delivered gas into the discharge flow passage 24 is by way of an opening region disposed in a second axial portion a2. Provided in the first axial portion al is a step 20 which prevents the gas from flowing radially directly out of the impeller 8 into the discharge flow passage 24. The impeller 8 is thus accommodated in a cup-shaped recess, leaving a sufficient peripheral gap, with substantial eradication of the flow noises caused by the impeller 8 being effected in the cup-like recess.

1. A blowing device comprising:
a housing (2),
at least one impeller (8) accommodated therein,
an intake opening (6), and
a discharge flow passage (24), wherein defined in the housing (2) in conjunction with the impeller (8) is a flow path which extends from a first axial level (12) of the housing (2), said level having the intake opening (6), into the discharge flow passage (24) over a step (20).

2. A blowing device according to claim 1 wherein the housing (2) has a peripheral wall (14) which in its configuration follows a spiral path which expands radially in the direction of rotation of the impeller.

3. A blowing device according to claim 1 or claim 2 wherein the peripheral wall (14) extends along a logarithmic spiral in the radial direction.

4. A blowing device according to one of claims 1 to 3 wherein the discharge flow passage (24) is a continuation of the spiral-shaped housing (2, 14).

5. A blowing device according to one of claims 1 to 4 wherein the step (20) has a flow breakaway edge (22).

6. A blowing device according to one of claims 1 to 5 wherein the step (20) is of a height (H) which corresponds at least to the axial height of the impeller.

7. A blowing device according to one of claims 1 to 6 wherein the flow breakaway step (20) extends between the largest and smallest radii (rₘₐₓ, rₘᵢₙ) of the housing spiral (14) in the direction of operation (18) of the turbine wheel (8).

8. A blowing device according to one of claims 1 to 7 characterised in that the impeller (8) is arranged in sunk relationship in a recess and the discharge flow from the recess into the discharge flow passage (24) is by way of a flow transfer edge (K) which extends substantially at the same heightwise level of the adjacent peripheral edge of the impeller.

9. A blowing device according to one of claims 1 to 8 wherein the flow breakaway step (20) extends at a substantially constant axial heightwise level (H).

10. A blowing device according to one of claims 1 to 9 wherein the intake opening (6) is provided at a first housing side (4) and the discharge flow passage (24) is provided at a second side of the housing (2, 14), which is separated by the turbine wheel (8).

11. A blowing device according to one of claims 1 to 10 wherein sound insulating means are provided in and/or on the housing (2, 14).

12. A blowing device according to one of claims 1 to 11 wherein the housing (2, 14) is an integral component.

13. A blowing device according to one of claims 1 to 12 wherein the housing (2, 14) is a plastic injection molding or an aluminum die casting.

14. A blowing device according to at least one of claims 1 to 1 3 wherein the impeller is accommodated in a recess whose axial depth (L) is greater than the axial depth (t) of the impeller (8), wherein the recess is defined by a peripheral wall which radially expands in the direction of rotation of the impeller and provided in the transitional region to the discharge flow passage is an outlet opening which is at an axial level (a2) which is axially displaced from the impeller (8).

15. A blowing device in particular according to at least one of claims 1 to 14, comprising:
a housing (2),
at least one impeller (8) accommodated therein, and
a drive device for driving the impeller,
wherein an intake flow path is established in an intake region in the housing (2), said intake region being upstream of the impeller (8), the flow path extending along a spirally wound course to an intake opening (6).

16. A blowing device according to at least one of claims 1 to 15 wherein the housing (2) defines a cup-like pressure chamber means and a cup-like suction chamber means, which are in mutually adjoining relationship by way of a common bottom means (4), and provided in the bottom means (4) is an intake opening (6) by way of which a flow of gas is permitted from the suction chamber means into the pressure chamber means.

17. A blowing device according to claim 16 characterised in that a respective cover element is provided for each of the two chamber means.

18. A blowing device according to claim 17 characterised in that the cover element of the suction chamber means is provided on its inside which is towards the chamber means, with a sound-absorbent lining.

19. A blowing device according to at least one of claims 1 to 18 characterised in that defined in the suction chamber means is a flow path which is curved inwardly in the flow direction spiral-like towards the intake opening (6) and that a flow path which enlarges radially spiral-like in the flow direction is defined in the pressure chamber means in conjunction with the housing (2).

20. Apparatus for feeding a respiration gas under increased pressure, comprising a blowing device according to at least one of claims 1 19.
